(19) United States
(12) Patent Application Publication
(10) Pub. No.: US 2026/0185405 A1
(43) Pub. Date: Jul. 2, 2026

(54) FOLDABLE WORK PLATFORM LADDER

(71) Applicant: DUARIB GROUP, Romilly-sur-Andelle (FR)

(72) Inventor: Arnaud PERRIER, Romilly-sur-Andelle (FR)

(73) Assignee: DUARIB GROUP, Romilly-sur-Andelle (FR)

(21) Appl. No.: 19/129,747

(22) PCT Filed: Nov. 8, 2023
(86) PCT No.: PCT/EP2023/081225

§ 371 Date: May 14, 2025

(30) Foreign Application Priority Data
Nov. 15, 2022 (FR) FR2211844

(51) Int. Cl. E06C 1/393; E06C 7/18; E06C 7/48

(52) U.S. Cl. CPC E06C 1/393; E06C 7/185; E06C 7/48

(57) ABSTRACT

Ladder having a climbing plane with a pair of rails and rungs, the ladder including a foldable work platform and a wall spacer, the work platform having a safety guard and a floor, the safety guard and the wall spacer forming an assembly pivotably connected to the climbing plane between a folded configuration wherein the safety guard and the wall spacer are folded back toward the climbing plane and a deployed configuration when the work platform is in use. The floor is pivotably connected to the climbing plane between a folded configuration wherein the floor is folded down toward the climbing plane and a deployed configuration when the work platform is in use. The mechanism for pivotably connecting the assembly formed by the safety guard and the wall spacer to the climbing plane is separate and independent from the mechanism for pivotably connecting the floor to the climbing plane.

The invention relates to the field of ladders (possibly telescopic) equipped with a foldable work platform.

“Ladder” here means a transportable device comprising a climbing plane.

“Telescopic ladder” here means a ladder the climbing plane of which comprises at least two elements mounted sliding with respect to one another. “Work platform” here means an assembly comprising a safety guard and a floor. “Foldable” here means that the work platform may be in a compact transport or storage position, or in a deployed position wherein a user can access or exit the work platform.

Ladders of this type are used in particular in the building sector for formwork or in the civil engineering sector for work on electric poles or pylons.

Ladders with a foldable work platform are most often used for short-term work and are designed to be portable.

Examples of such ladders can be found in documents FR2892146 (AUDINNOV, 2007), FR2927649 (AUDINNOV, 2009), FR2926590 (DUARIB, 2009), FR2990988 (AUDINNOV, 2013).

Ladders of this type are of a different structure and use than those of the mobile platforms presented in standard NF EN 131-7, of the individual rolling platform (PIR) or individual lightweight mobile platform (PIRL).

First of all, individual rolling platforms comprise a climbing plane and support plane and, if necessary, stabilising feet. The support plane extends to the front of the platform. The weight of the platform rests on the floor, by the feet of the climbing plane and the feet of the support plane.

A foldable work platform ladder, in the deployed position of the work platform, bears against a structure. Such a ladder conventionally comprises a device for bearing against this structure. Such a device is often referred to as a support cradle. Depending on the intended use of the ladder, the support cradle comprises wheels or rubber pads. Document FR3012510 (CDH, 2015) presents a cradle for supporting a ladder against a pylon. Document EP3995665 (STAASAEKER, 2022) presents a spacer comprising wheels, for the bearing of a ladder against a façade. Reference can also be made to document EP2454440 (EASI, 2013).

Secondly, an individual rolling platform allows access to a work platform comprising a floor located at a maximum height of 2.5 m above the ground, according to standard NF P 93-352. A lightweight individual rolling platform allows access to a work platform comprising a floor at a maximum height of 1.5 m above the floor.

In ladders with a foldable work platform, the work platform floor is generally located at a height of around 3 to 6 metres.

An individual rolling platform can be folded out easily by one person, with the legs of the climbing and bearing plane providing stability to the platform during this folding out. The same is not true for ladders equipped with a foldable work platform, the deployment of the work platform being tiring, complicated, or even dangerous in the designs proposed in the prior art.

Document EP 1783322 (TUBESCA, 2007) describes a ladder the climbing plane of which comprises two sliding elements, the ladder being provided with a foldable assembly comprising a floor and a safety guard. The floor is pivotably connected to a rung of the climbing plane, and is pivotably connected to the rails of the climbing plane by two tie rods. The safety guard comprises a lower beam and an upper beam, the two beams being connected by two lateral legs and each being pivotably connected to the rails of the climbing plane. Each of the lateral legs is mounted sliding on a post, by a support part comprising a lock. A pin carried by the lock slides in a groove of the post. To deploy the work platform, the ladder is placed at an angle to the vertical, and the floor pivots by gravity to its horizontal position. The operator then exerts a thrust on these two lateral legs, causing the upper beam and the lower beam of the safety guard to pivot. The deployment of the work platform may be hindered by deposits, for example filler or plaster, in the sliding grooves of the lateral legs, or on the pivot axes of the upper beam and of the lower beam. Pivoting the safety guard when manually thrusting on the lateral legs involves eight joints and two sliding grooves, multiplying the risk of blocking due to dirt. Pivoting of the floor by gravity may not be achieved, for the same reasons.

Document FR2907493 (AUDINNOV, 2008) describes a ladder the climbing plane of which comprises two sliding elements, the ladder being provided with a foldable work platform comprising a floor and a U-shaped frame forming a safety guard. The floor and the safety guard are each pivotably connected on a bar of the climbing plane, and are connected by a connecting rod. To deploy the work platform, the operator must climb the climbing plane, operate a lock with one hand and, with the other hand, lift the safety guard up or push the floor down. As the ladder rests against a wall during this manoeuvre, the pivoting of the floor can be blocked by a relief present on this wall, for example a window sill. In addition, the ladder may have been splashed with paint, cement, plaster or filler during use. Such deposits on the pivot pins of the floor or safety guard involve greater manual forces for the deployment of the work platform, these forces can affect the stability of the ladder, with the resulting risks of the operator falling.

Document FR2918408 (AUDINNOV, 2009) describes a ladder provided with a work platform comprising a floor and a safety guard, the floor being pivotably connected to a bar of the climbing plane and being connected to the safety guard by connecting rods. Each connecting rod is provided with a collar mounted sliding on the safety guard. To deploy the work platform, the operator must climb the climbing plane and exert a force on the floor to rotate it horizontally, this pivoting must cause the connecting rods to move to the safety guard. The operator must check that the connecting rods are in position, and if not, slide the collars onto the safety guard. The ladder has the disadvantages of that described in document FR2907493, the deployment of the work platform being also longer and more complicated.

One object of the invention is to overcome the disadvantages of the prior art, by proposing a ladder equipped with a foldable work platform, the ladder offering better ergonomic and safety qualities, while being simple to use and offering great compactness in folded configuration.

For these purposes, it is proposed, according to a first aspect, a ladder comprising a climbing plane having a pair of rails and rungs transversely connecting the rails, the ladder comprising a foldable work platform and a wall spacer, the work platform comprising a safety guard and a floor, the safety guard and the wall spacer forming an assembly that is pivotably connected to the climbing plane, between a folded configuration wherein the safety guard and the wall spacer are folded back toward the climbing plane and a deployed configuration when the work platform is in use, the floor being pivotably connected to the climbing plane between a folded configuration wherein the floor is folded toward the climbing plane and a deployed configuration when the work platform is in use, the means for pivotably connecting the assembly formed by the safety guard and the wall spacer to the climbing plane being separate and independent from the means for pivotably connecting the floor to the climbing plane.

The deployment of the assembly formed by the safety guard and the wall spacer can thus be obtained before uprighting the ladder, after having deployed the floor. The user can deploy the work platform safely, with both hands available for manoeuvring, without the weight of the ladder being an inconvenience. When the work platform has been set in the deployed configuration, the user can tilt the climbing plane and place the ladder in its position of use.

Advantageously, the safety guard comprises an access gate to the work platform. According to various embodiments, the gate may comprise one or more bars, or a panel extending over the entire width of the work platform, the gate opening upwards or inwards or outwards from the work platform.

In certain embodiments, in the deployed configuration of the work platform, the safety guard comprises two vertical posts and two horizontal posts, the vertical and horizontal posts extending on either side of the climbing plane, each vertical post being mounted sliding on a guide fastened to a rail of the climbing plane, the guide being pivotable transversely with respect to the rail of the climbing plane, each horizontal post being pivotably mounted on a vertical post, each horizontal post being pivotably mounted to a rail climbing plane.

In the folded configuration of the assembly formed by the safety guard and the wall spacer, the vertical and horizontal posts of the safety guard are advantageously arranged parallel and at a short distance from the rails of the climbing plane. The ladder can thus be transported or stored in a very compact configuration.

According to certain embodiments, a guide part is mounted sliding on each of the rails of the climbing plane, each guide part being connected to the wall spacer by a connecting bar, each guide part being connected to a vertical post of the safety guard by a connecting tube, the sliding of each guide part on its support rail, between a first extreme position and a second extreme position causing the movement of the assembly formed by the safety guard and the wall spacer between the deployed configuration of use of the work platform and its folded configuration.

The manual manoeuvring of the two guide parts is advantageously carried out before uprighting the climbing plane, the ladder being lying on the ground. The user can thus ensure the perfect deployment of the floor and the assembly formed by the safety guard and the wall spacer, before uprighting the climbing plane. The user can then climb on the climbing plane and start work, without having to perform any further intervention for the deployment of the work platform.

Advantageously, locking means are able to hold at least one guide part in its first extreme position, wherein the assembly formed by the safety guard and the wall spacer is in its deployed configuration.

Advantageously, locking means are able to hold at least one guide part in its second extreme position, wherein the assembly formed by the safety guard and the wall spacer is in its folded configuration.

The locking means are advantageously locking hands, the actuation of which is carried out manually against a return means, such as for example a tension or torsion spring. Advantageously, the floor is pivotably connected, by a front edge, to the climbing plane, in transverse rotation, the floor being in its configuration deployed bearing on a rear edge on a support tube, the support tube being pivotably connected in transverse rotation to the climbing plane, a guide being mounted sliding on the support tube, the guide being mounted in transverse rotation at the rear edge of the floor.

Advantageously, a damper is placed between the support tube and the floor.

In certain embodiments, the climbing plane comprises at least two parts slidably mounted with respect to one another.

Advantageously, two stabilisers are pivotably connected to the climbing plane. These stabilisers form support legs or struts. The stabilisers are advantageously telescopic, and comprise for example a sliding tube in a sleeve, means for adjusting the length of the stabilisers, for example holes in the tube facing a hole in the sleeve for passing a pin, or a blocking of the sliding tube by friction using a part connected to the sleeve.

Other objects and advantages of the invention will appear in light of the description of an embodiment, given hereinafter in reference to the appended figures wherein:

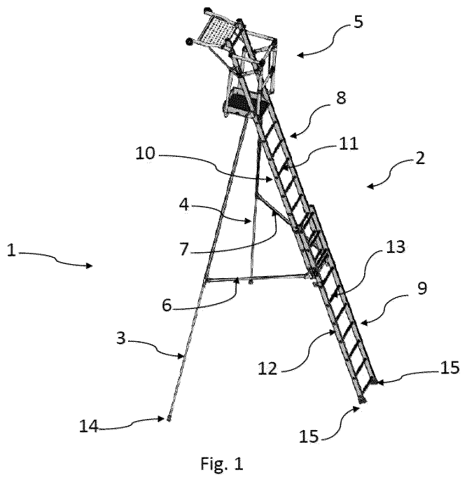

FIG. 1 is a perspective view of a ladder equipped with a foldable work platform, the ladder being shown in deployed configuration;

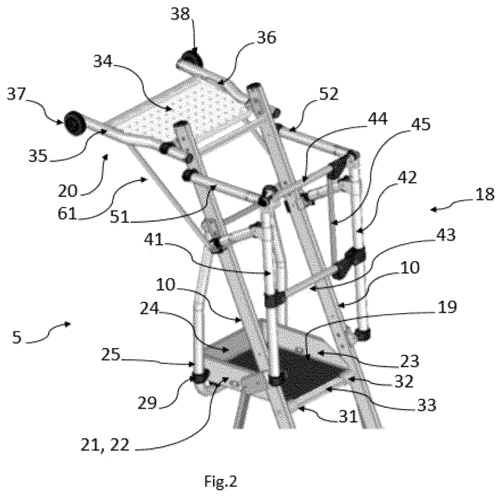

FIG. 2 is a perspective view of the work platform of the ladder shown in FIG. 1;

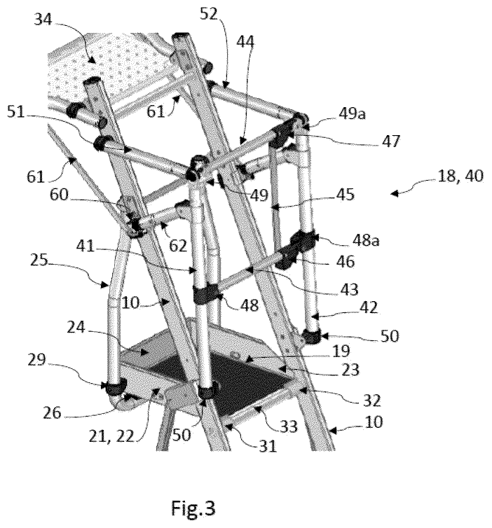

FIG. 3 is a perspective view of the work platform shown in FIG. 1, illustrating more particularly the safety guard;

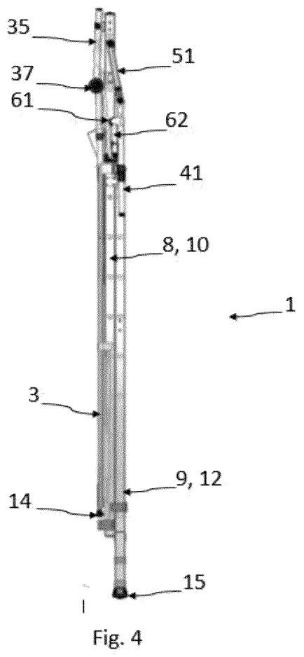

FIG. 4 is a side view of the ladder of FIG. 1, shown in compact folded, storage or transport configuration;

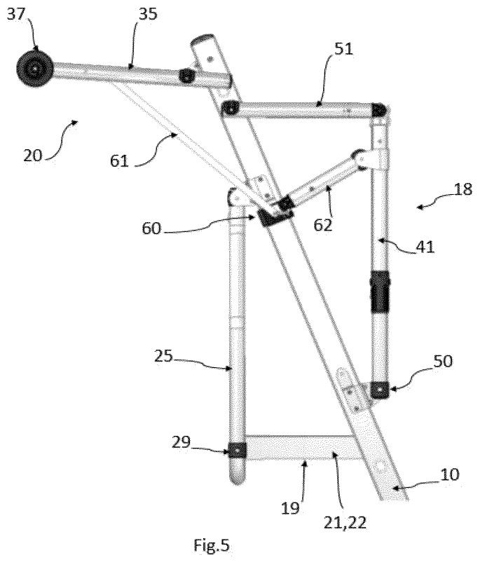

FIG. 5 is a side view of the upper part of the ladder shown in FIG. 1, the work platform being in deployed configuration;

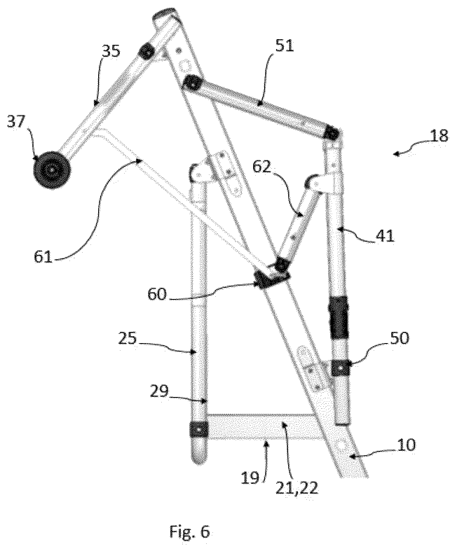

FIG. 6 is a side view of the upper part of the ladder shown in FIG. 1, the assembly formed by the safety guard and the wall spacer being in an intermediate folded position, the floor being in its deployed configuration;

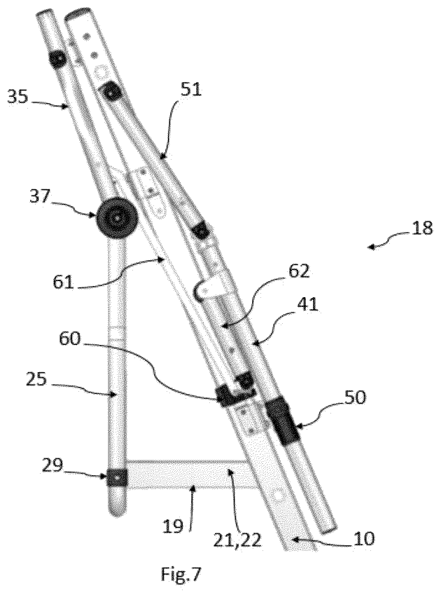

FIG. 7 is a side view of the upper part of the ladder shown in FIG. 1, the assembly formed by the safety guard and the wall spacer being in its folded configuration, the floor being in its deployed configuration;

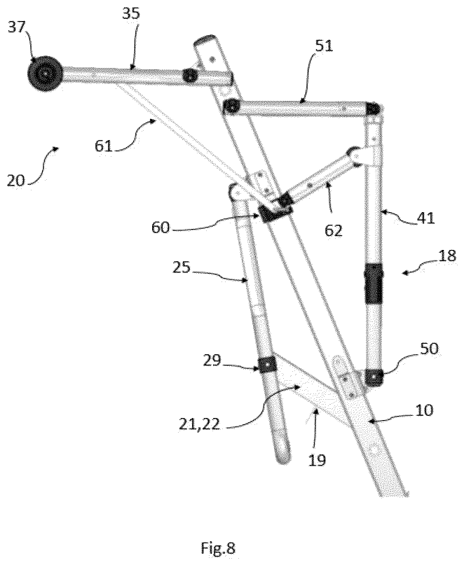

FIG. 8 is a side view of the upper part of the ladder shown in FIG. 1, the floor being in an intermediate folded position, the assembly formed by the safety guard and the wall spacer being in its deployed configuration;

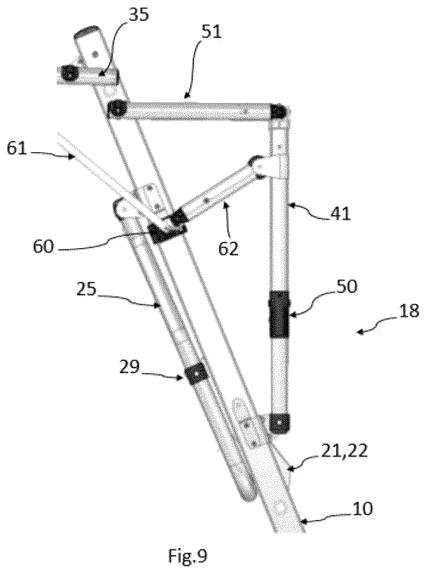

FIG. 9 is a side view of the upper part of the ladder shown in FIG. 1, the floor being in its folded configuration, the assembly formed by the safety guard and the wall spacer being in its deployed configuration;

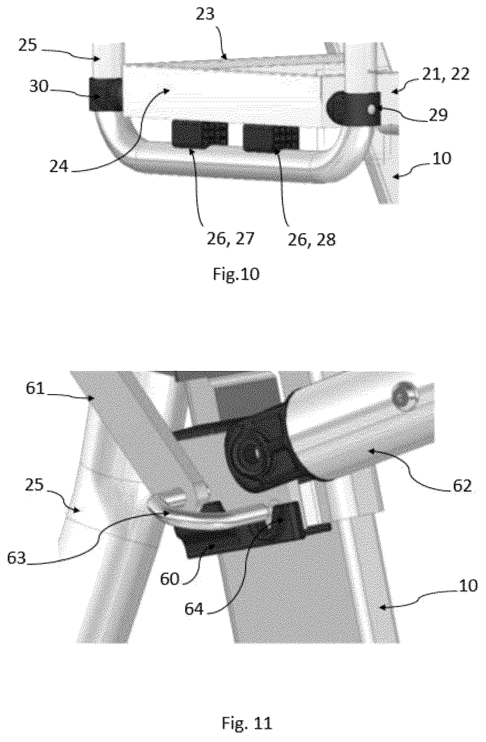

FIG. 10 is a detailed view of the bearing of the floor on its support, in the deployed configuration of the floor;

FIG. 11 is a detailed view of the locking means of the assembly formed by the safety guard and the wall spacer.

In the remainder of this description, the terms “horizontal”, “vertical” are used in reference to the ladder in the deployed position, resting on the ground.

FIG. 1 shows a telescopic ladder equipped with a foldable work platform.

The ladder 1 comprises a climbing plane 2, two stabilisers 3, 4, and a foldable work platform 5. Each of the two stabilisers 3, 4 is pivotably connected to the climbing plane 2 by a brace 6, 7.

In the embodiment shown, the climbing plane 2 comprises an upper part 8 mounted sliding on a lower part 9. The climbing plane 2 thus comprises two planes.

In other embodiments, not shown, the climbing plane comprises more than two planes, for example three to five planes, making it possible to achieve high working heights, for example of more than ten meters.

The ladder advantageously comprises a parachute making it possible to lock and unlock the elements of the climbing plane.

In the embodiment shown, the upper part 8 comprises two substantially parallel rails 10 and ten cross members 11 fastened to the rails 10 (nine cross members 11 for access to the work platform 5 and a last cross member 11 at the upper end of the climbing plane 2, reinforcing the rigidity), the lower part 9 comprising two substantially parallel rails 12 and ten cross members 13 fastened to rails 12.

In other embodiments, not shown, the upper portion and/or the lower portion of the climbing plane comprises less than ten cross members, for example between four and seven cross members.

Ladder 1 is provided with means that reduce the risk of slipping.

In the embodiment shown, each stabiliser 3, 4 is provided with an anti-slip pad 14, and each of the two rails 12 of the lower part 9 of the climbing plane 2 is provided with an anti-slip pad 15.

The pads 14, 15 are for example made of elastomer material.

In an implementation, the pads 15 of the climbing plane 2 comprise a lower part in contact with the ground, and an upper part for fastening to the rails 12. In a particular implementation, the lower part of the pads 15 is made of a flexible material, and the upper part of the pads is made of a rigid material, the pads 15 being manufactured according to a two-material process.

In certain embodiments, the rails 12 are formed of hollow profiles, and the pads 15 run against the base of the rails or are mounted by force insertion in the rails 12.

In an embodiment, the pads 14 of the stabilisers 3, 4 comprise a lower part of contact with the ground, and an upper part of attachment to the stabilisers 3, 4. In a particular embodiment, the lower part of the pads 14 is made of a flexible material, and the upper part for fastening the pads is made of a rigid material, the pads 14 being manufactured according to a two-material process.

In the embodiment shown, each stabiliser 3, 4 comprises a tubular body and a lower profile mounted sliding relative to the body, the lower profile bearing a pad 14. In certain embodiments, the lower profile is hollow and the pad 14 is mounted for insertion into the lower profile. In other embodiments, the pad 14 runs on the base of the lower profile.

In other embodiments, each stabiliser 3, 4 comprises a lower tubular body and an upper profile mounted sliding with respect to the body, the pad 14 being mounted for insertion into the lower tubular body or running on the base of the lower tubular body.

In certain embodiments, the pads 15 are mounted pivotably connected to the rails 12. The ladder 1 is advantageously provided with means reinforcing its stability in the deployed position.

In certain embodiments, the climbing plane is provided at its base with a stabilising bar, in particular telescopic, or supports.

In certain embodiments, the rails of the climbing plane are further apart from each other at the base of the climbing plane.

In the embodiment shown, the body of each stabiliser 3, 4 is pivotably connected by a brace 6, 7 to a rail 10 of the upper part 8 of the climbing plane 2.

In other embodiments, each stabiliser is pivotably connected by a brace to a rail of the lower portion of the climbing plane.

In the compact storage or transport position of the ladder 1, the lower profile is retracted into the body and the brace 6 is substantially parallel to the rail 10 of the climbing plane.

The cross members 11, 13 form bars or rungs serving as degrees for climbing up or down.

In the embodiment shown, the cross members 11, 13 are substantially equidistant.

In certain embodiments, the climbing plane 2 is formed by the assembly of metal, steel or aluminium alloy rails and cross members.

The cross members can be assembled to the rails by welding, screwing, tacking, or by joining with the insertion of force-locking parts, to lock the cross members in their joining position.

Cross members can be joined to the rails by tube expansion or crimping.

For crimp assembly, the rungs are provided, on their two lateral ends, with at least one shrinkage which engages in holes in the rails. The end of these shrinkages protrudes on the outer face of the rails and is deformed by crimping, or by rolling, tulipping, or stamping. Simple crimping leads to deformation of the shrinkage on the outer side of the rail. Double crimping, carried out on both the outer face and the inner face of the rail, allows greater mechanical strength than simple crimping, since it allows clamping on either side of the wall of the rail.

For joining by tube expansion, the tube expander is for example mechanical and comprises a drum, rollers or needles and a conical spindle. The conical spindle (or tube expander tail) advances inside the profile forming the cross member. This spindle is rotated by an electric or pneumatic tube expanding machine. The spindle increases the circumference of the rollers while rotating them. The rollers thus cause the expansion of the profile forming the cross member. This expansion is carried out while the profile forming the cross member was inserted into an opening made in the rail. It is thus possible to form beads on the cross member, these beads being placed on either side of at least one of the walls of the rail.

The assembly of the cross members to the rails is advantageously carried out by rolling, tamping, tulipping, crimping, leading to a plastic deformation of the two ends of the cross members, this plastic deformation being advantageously ensured simultaneously on the two end portions of the cross members.

In the embodiment shown, the rails 10, 12 forming posts of the climbing plane 2 have a rectangular cross-section and the cross members 11, 13 have a square cross-section. A cross-section here means a section following a plane perpendicular to the direction of slenderness of an element.

In other embodiments, not shown, the cross members are of circular, rectangular oval or polygonal cross-section, the rails being of circular, oval or polygonal cross-section.

Advantageously, the cross members comprise, in their portion located between the rails, reliefs such as grooves or folds. In particular, these reliefs prevent the user's foot or hand from slipping when climbing or descending the ladder 1.

In an embodiment, these reliefs are undulations in the thickness of the profile forming the cross member, the thickness of this profile, measured in cross-section of the cross member, being substantially constant.

In other embodiments, at least part of the cross members of the climbing plane is provided with an added anti-slip material, such as an elastomer strip, or a plate made of embossed metal, ribbed, perforated, expanded metal or grating.

In certain embodiments, the ladder is formed by assembling a non-conductive material, for example a mineral fibre composite material such as glass fibre, or a plant fibre such as flax fibre. For example, the profiles forming the rails and cross members of the climbing plane are pultruded.

These arrangements are advantageous when the ladder is intended for electrical work or for outdoor work in the vicinity of power lines.

In the embodiment shown, the foldable work platform 5 is permanently attached to the ladder 1, in the upper part.

In other embodiments, not shown, the foldable work platform is attached to the ladder, removably.

The work platform 5 comprises a safety guard 18, a floor 19 and a wall spacer 20.

In the embodiment shown, the work platform 5 comprises folded or bent tubular elements, for example made of steel or aluminium alloy.

When the ladder is intended for electrical work or for work outdoors in the vicinity of electrical cables, the tubes forming the work platform are advantageously made of insulating material, such as composite material, for example with polymer matrix and fibreglass reinforcement.

The safety guard 18 and the wall spacer 20 form a foldable and unfoldable assembly in one movement, independent from the folding and unfolding movement of the floor 19.

The floor 19 is now described more particularly.

The floor 19 is advantageously non-slip and has, for example, a waffled, ribbed or perforated surface. The floor 19 may be made of metal, in particular of aluminium alloy or steel, or even of composite, for example with polymer matrix and glass fibre reinforcement, or even of wood.

The floor 19 advantageously comprises a plinth 21. In the embodiment shown, the plinth 21 comprises three sections 22, 23, 24 substantially perpendicular to the floor 19, namely two lateral sections 22, 23 and a junction section 24. When the ladder 1 is in the deployed position for use, the floor 19 is substantially horizontal and the junction section 24 is substantially vertical and arranged opposite the climbing plane 2.

The plinth 21 limits the risks of falling objects such as, for example, tools that would be on the floor 19. The plinth 21 forms a stop for the user's feet, limiting the risk of falling.

The height of the plinth 21 is advantageously about ten centimetres or more than ten centimetres.

In an embodiment, the floor 19 and the plinth 21 have from a single piece, for example from an injection moulding.

In other embodiments, the plinth is fixed to the floor. In certain embodiments, the plinth is hinged to the floor between a compact position, wherein the plinth is substantially parallel to the floor, and a deployed position of use.

The width of the floor 19 is for example forty centimetres. In the embodiment shown, the floor 19 is substantially square.

In other embodiments, not shown, the floor is rectangular.

In the deployed position, the floor 19 bears on a support 25. In the embodiment shown, the support 25 comprises a bent tube, rotatably pivotably connected to the rails 10 of the upper part 8 of the climbing plane. A bumper 26 is placed between the bent tube of the support 25 and the floor 19. This bumper 26 can be supported by the bent tube of the support 25 or be supported by the floor 19.

In the embodiment shown, the bumper 26 is formed by two dampers 27, 28, advantageously made of elastomer material, arranged between the floor 19 and the bent tube of the support 25. These dampers 27, 28 are for example fastened by screwing to the bent tube of the support 25.

The presence of these dampers 27, 28 ensures a gentle and noiseless contact of the floor 19 on the support 25, when unfolding the work platform.

The presence of these dampers 27, 28 ensures comfort for the user of the ladder 1, during his movements in the work platform 5, the dampers 27, 28 absorbing the vibrations and pressures exerted on the floor 19.

The floor 19 is rotatably pivotably connected to the support 25.

In the embodiment shown, the bent tube of the support 25 comprises two guides 29, 30 slidably mounted on the bent tube of the support 25, each of the two guides 29, 30 being pivotably mounted on a lateral section 22, 23 of the plinth 21.

The floor 19 is rotatably pivotably connected to the climbing plane 2.

In the embodiment shown, the floor 19 carries two knuckles 31, 32 receiving a cross member 33 of the climbing plane 2. The term knuckle here means a part comprising a recess wherein the cross member 33 forming a joint pin passes.

The knuckles 31, 32 are for example fastened to the floor 19 by screwing, welding, or riveting.

In the deployed position, the floor 19 bears on the support 25. In the embodiment shown, no mechanical lock is used in this deployed position.

In other embodiments, not shown, a mechanical lock, for example a pin, ensures that the floor is held in the deployed position.

The folding of the floor 19 is obtained by sliding the guides 29, 30 on the support 25, the rotation of the floor 19 with respect to the guides 29, 30, the rotation of the floor 19 with respect to the cross member 33, and the rotation of the support 25 with respect to the rails 10 of the climbing plane 2.

During this pivoting, the floor 19 gradually moves from a substantially horizontal position to a storage position, wherein the floor 19 is positioned between the rails 10 of the climbing plane 2.

In this storage position, the bent tube of the support 25 is substantially parallel to the rails 10 of the climbing plane.

The wall spacer 20 is now described.

In the embodiment shown, the wall spacer 20 comprises a plate 34 arranged between two bent tubes 35, 36. When the wall spacer 20 is in the deployed position, the plate 34 is substantially horizontal, and arranged substantially at the height of the pelvis of a person located on the work platform 5.

The plate 34 allows the user to place tools, pots or buckets. In certain embodiments, not shown, the plate comprises housings whose shapes are adapted to specific tools.

Each of the bent tubes 35, 36 bears a bearing member 37, 38 such as a wheel or a pad, allowing the ladder 1 to bear against a façade or a wall.

In certain embodiments, not shown, the wall spacer is of the telescopic type, allowing adjustment of the distance between the work platform and the façade or wall against which the ladder is bearing.

In certain embodiments, not shown, the wall spacer comprises an accessory allowing it to bear against a post.

The bent tubes 35, 36 are rotatably pivotably connected to the rails 10 of the climbing plane 2.

The safety guard 18 is now described.

In the embodiment shown, the safety guard 18 comprises a gate 40 pivotably connected on two vertical posts 41, 42. The gate 40 comprises a lower bar 43, an upper bar 44 and a connecting flat 45 hinged to the upper bar 44 and to the lower bar 43.

A connecting yoke 46 connects the lower bar 43 and the flat 45. A connecting yoke 47 connects the upper bar 44 and the flat 45.

The lower bar 43 is pivotably mounted on a joint yoke 48 fastened to a vertical post 41.

Similarly, the upper bar 44 is pivotably mounted on a joint yoke 49 fastened to the vertical post 41.

When the gate 40 is in the closed position of the work platform 5, the upper and lower bars 43, 44 are substantially horizontal and parallel. The free end of the lower bar 43 is then supported on a support yoke 48a mounted on the second vertical post 42.

Similarly, the free end of the upper bar 44 is then supported on a support yoke 49a mounted on the second vertical post 42.

The joint yokes 48, 49, and the support yokes 48a, 49a are for example formed by assembling parts made of polymer material, the assembling of the parts and the mounting of the yokes on the posts 41, 42 being for example carried out by screwing.

The assembly formed by the lower bar 43, the upper bar 44, and the connecting plate 45 can be moved manually by pivoting. In the opening position of the gate 40, the two bars 43, 44 are brought into a substantially vertical position. The return to the closed position of the gate 40 is ensured by the own weight of the assembly formed by the bars 43, 44 and the connecting flat 45.

The gate 40 is thus opened substantially in a vertical plane, without the gate 40 being driven towards the inside of the work platform 5, or towards the front of the climbing plane 2.

In some embodiments, a return means such as for example a torsion spring ensures automatic closing of the gate.

In certain embodiments, a locking device ensures the holding of the lower bar 43 and/or the upper bar 44 in the horizontal closing position of the work platform 5.

In the embodiment shown, the bars 43, 44 of the gate 40 are pivotably connected to the vertical post located to the left of the climbing plane 2.

In other embodiments, not shown, the bars 43, 44 of the gate 40 are pivotably connected to the post located to the right of the climbing plane 2.

In the embodiment shown, the gate 40 is formed of an assembly forming a single leaf, extending over the entire width of the work platform 5.

In other embodiments, the gate comprises two assemblies each extending over a portion of the width of the work platform. For example, the gate comprises bars pivotably connected on the vertical post located to the right of the climbing plane, and further comprises bars pivotably connected on the vertical post located to the left of the climbing plane.

In other embodiments, not shown, the gate is pivotably connected to one of the vertical posts 41, 42 and opens towards the inside of the work platform. When climbing into the work platform, the gate opens when the user passes through, and closes behind him, advantageously automatically, by the weight of the gate and, where applicable, by a means of recall.

In other embodiments, the gate is pivotably connected to one of the vertical posts 41, 42 and opens outwardly from the work platform.

Each vertical post 41, 42 is slidably mounted on a guide 50, each guide 50 being pivotably mounted on a rail of the climbing plane 2.

Each vertical post 41, 42 is further pivotably connected to a horizontal post 51, 52, each horizontal post 51, 52 being pivotably connected to a rail 10 of the climbing plane 2.

The work platform 5 is provided with two guide parts 60, each of these two guide parts 60 being slidingly mounted on a rail 10 of the climbing plane 2.

Each guide part 60 is connected to the wall spacer 20 by a connecting bar 61.

Each guide part 60 is connected to a vertical post 41, 42 by a connecting tube 62.

The pivoting of the assembly formed by the safety guard 18 and the wall spacer 20, from a deployed position of use of the work platform 5 to a compact transport or storage position of the ladder 1, is now described.

In a first step, a locking device is actuated manually.

In the embodiment shown, a locking hand 63 is unlocked, on each side of the climbing plane 2, the locking hand 63 being held in the locked position by a return means such as a spring. The locking is for example obtained by passing an end of the locking hand 63 into a hole in the rail. Alternatively, the locking is achieved by friction.

The locking hand 63 is pivoted about its main pin and is then inserted into a housing 64, making it possible to hold the locking hand 63 in the open position, during the sliding of the guide part 60.

In a second step, a sliding of the guide parts 60 is carried out, along the rails 10 of the climbing plane 2.

During this sliding, the wall spacer 20 pivots to position itself in a plane substantially parallel to the climbing plane 2.

When sliding the guide parts 60, the horizontal posts 51, 52 pivot to position themselves in a plane slightly inclined with respect to the climbing plane 2.

When sliding the guide parts 60, the vertical posts 41, 42 pivot with respect to the rails 10 by sliding in the guides 50. At the end of pivoting, the vertical posts 41, 42 are arranged in a plane substantially parallel to the climbing plane 2.

In a third step, locking of the ladder 1 in the folded position is ensured, by actuating the locking hands 63.

When the sliding of the guide part 60 is complete, the locking hand 63 is pivoted about its main pin, and the main pin of the locking hand 63 fits into a hole of the rail 10 of the climbing plane, ensuring the blocking.

In one alternative, the pivoting of the locking hand is done automatically to either or both end positions.

Work platform 5 has a high level of safety.

A workspace is delimited laterally by the upper end portions of the two rails 10. This workspace is secured, in particular with regard to falling hazards, at different heights of the user's body.

A first safety device, at the height of the user's feet, is provided by the plinth 21.

A second safety device, at the height of the user's legs, is provided by the lower bar 43 of the gate 40 and by the end portions of the two rails 10.

A third safety device, at the height of the user's pelvis, is provided by the upper bar 44 of the gate 40, by the two horizontal posts 51, 52 of the safety guard 18, and by an upper cross member 53.

The workspace is thus completely secured, over 360°, and therefore against the risks of falling forwards, from the side or to the rear.

Advantageously, the work platform is provided with means for preventing the accidental opening of the gate outwards, when the user present in the work platform leans on the gate.

The ladder 1 is easy to use.

Starting from a compact storage position of the ladder 1, laid on the ground, the floor 19 can be placed manually in the deployed position. The ladder 1 is then bearing on the ground, at the base of the rails of the climbing plane 2 (where the pads 15 are located), and by the support 25 of the floor 19.

The user can then manually deploy the assembly formed by the safety guard 18 and the wall spacer 20. During this manual deployment, the bearing members 37, 38 such as wheels can bear against the ground. The deployment of the assembly formed by the safety guard and the wall spacer is thus obtained while the ladder 1 is on the ground. The user can deploy the work platform safely, with both hands available for manoeuvring, without the weight of the ladder 1 being an inconvenience.

When the work platform is deployed, the user can tilt the climbing plane and place the stabilisers 3, 4 bearing on the ground.

1. Ladder comprising a climbing plane that has a pair of rails and rungs transversely connecting the rails the ladder comprising a foldable work platform and a wall spacer, the work platform comprising a safety guard and a floor, the safety guard and the wall spacer forming an assembly that is pivotably connected to the climbing plane between a folded configuration wherein the safety guard and the wall spacer are folded back toward the climbing plane and a deployed configuration when the work platform is in use, the floor being pivotably connected to the climbing plane between a folded configuration wherein the floor is folded down toward the climbing plane and a deployed configuration when the work platform is in use, the means for pivotably connecting the assembly formed by the safety guard and the wall spacer to the climbing plane being separate and independent from the means for pivotably connecting the floor to the climbing plane.

2. Ladder according to claim 1, wherein the safety guard comprises a gate for accessing the work platform.

3. Ladder according to claim 1, wherein in the deployed configuration of the work platform, the safety guard comprises two vertical posts and two horizontal posts, the vertical and horizontal posts extending on either side of the climbing plane, each vertical post being slidably mounted on a guide attached to a rail of the climbing plane, the guide being pivotable transversely with respect to the rail of the climb plane, each horizontal post being pivotably mounted to a vertical post, each horizontal post being pivotably mounted to a rail of the climbing plane.

4. Ladder according to claim 3, wherein guide part is mounted sliding on each of the rails of the climbing plane each guide part being connected to the wall spacer by a connecting bar, each guide part being connected to a vertical post of the safety guard by a connecting tube, the sliding of each guide part on its support rail, between a first extreme position and a second extreme position causing the assembly formed by the safety guard and the wall spacer to move between its deployed configuration for using the work platform and its folded configuration.

5. Ladder according to claim 4, wherein locking means are able to hold at least one guide part in its first extreme position, wherein the assembly formed by the safety guard and the wall spacer is in its deployed configuration.

6. Ladder according to claim 4, wherein locking means are able to hold at least one guide part in its second extreme position, wherein the assembly formed by the safety guard and the wall spacer is in its folded configuration.

7. Ladder according to claim 1, wherein the floor is pivotable, by a front edge, to the climbing plane, in transverse rotation, the floor being in its configuration deployed bearing on a rear edge on a support tube, the support tube being pivotably connected in transverse rotation to the climbing plane, a guide being mounted sliding on the support tube, the guide, mounted in transverse rotation to the rear edge of the floor.

8. Ladder according to claim 7, wherein, in the deployed configuration of the floor, a damper is placed between the support tube and the floor.

9. Ladder according to claim 1, wherein the climbing plane comprises at least two parts slidably mounted with respect to one another.

10. Ladder according to claim 1, wherein two stabilisers are pivotably connected to the climbing plane.
